(19) United States
(12) Patent Application Publication
(10) Pub. No.: US 2026/0303870 A1
(43) Pub. Date: Oct. 1, 2026

(54) METHOD AND APPARATUS FOR ENCODING/DECODING IMAGE AND RECORDING MEDIUM FOR STORING BITSTREAM

(71) Applicants: HYUNDAI MOTOR COMPANY, Seoul (KR); Kia Corporation, Seoul (KR)

(72) Inventors: Jungah CHOI, Hwaseong-si, Gyeonggi-do (KR); Jin HEO, Hwaseong-si, Gyeonggi-do (KR); Seung Wook PARK, Hwaseong-si, Gyeonggi-do (KR)

(73) Assignees: HYUNDAI MOTOR COMPANY, Seoul (KR); Kia Corporation, Seoul (KR)

(21) Appl. No.: 19/476,076

(22) PCT Filed: Jun. 14, 2024
(86) PCT No.: PCT/KR2024/008238

§ 371 Date: Oct. 16, 2025

(30) Foreign Application Priority Data
Jun. 21, 2023 (KR) 10-2023-0079490
Jun. 14, 2024 (KR) 10-2024-0077675

(51) Int. Cl. H04N 19/70; H04N 19/11; H04N 19/136; H04N 19/176; H04N 19/593

(52) U.S. Cl. CPC H04N 19/70; H04N 19/11; H04N 19/136; H04N 19/176; H04N 19/593

(57) ABSTRACT

A method and apparatus for encoding/decoding an image, a recording medium for storing a bitstream, and a transmission method are provided. The method for decoding the image includes obtaining a bin string corresponding to a syntax element from a bitstream, wherein the syntax element represents a combination of an intra prediction mode of a current block and a reference sample lines used for intra prediction, obtaining the syntax element by inverse-binarizing the bin string, and performing the intra prediction of the current block based on the syntax element. At least a portion of bins of the bin string may be obtained by bypass decoding, and bins of the bin string other than the bypass-coded bins may be obtained by arithmetic decoding.

### TECHNICAL FIELD

The present invention relates to a method and apparatus for encoding/decoding an image and a recording medium for storing a bitstream. Particularly, the present invention relates to a method and apparatus for encoding/decoding an image, as well as a recording medium storing a bitstream, with respect to a syntax element used for template-based multiple reference line (TMRL) intra prediction.

### BACKGROUND ART

Recently, the demand for high resolution and high quality images such as ultra high definition (UHD) images increases in various application fields. As image data becomes higher in resolution and quality, the amount of data increases relatively compared to existing image data. Therefore, when transmitting such image data using existing media such as wired or wireless broadband channels, or when storing it using existing storage media, both transmission and storage costs increase. To solve these problems that occur as image data becomes higher in resolution and quality, a high-efficiency image encoding/decoding technique is required for images with higher resolution and image quality.

Context-based adaptive binary arithmetic coding (CABAC), which is one of the entropy encoding methods, provides high coding performance. However, CABAC has disadvantage of having low throughput. This is due to a regular coding engine of CABAC. Specifically, in the regular coding engine, the probability state and range updated through the coding of a previous bin are used for coding a next bin. Accordingly, each bin has high data dependency and is not processed in parallel. In addition, reading a probability range and determining a current state may also take a considerable amount of time.

Therefore, various tools are being discussed to improve entropy coding efficiency.

### DISCLOSURE

### Technical Problem

An object of the present invention is to provide a method and apparatus for encoding/decoding an image with improved encoding/decoding efficiency.

Another object of the present invention is to provide a recording medium for storing a bitstream that is generated by generated by a method or apparatus for decoding an image according to the present invention.

Another object of the present invention is to provide a prediction method for solving the above-described existing problem of entropy coding, with respect to a syntax element used for template-based multiple reference line (TMRL) intra prediction.

### Technical Solution

A method for decoding an image according to an embodiment of the present invention includes obtaining a bin string corresponding to a syntax element from a bitstream, wherein the syntax element represents a combination of an intra prediction mode of a current block and a reference sample lines used for intra prediction, obtaining the syntax element by inverse-binarizing the bin string, and performing the intra prediction of the current block based on the syntax element. At least a portion of bins of the bin string may be obtained by bypass decoding, and bins of the bin string other than the bypass-coded bins may be obtained by arithmetic decoding.

In the method for decoding the image, the intra prediction of the current block may use an intra prediction mode indicated by the syntax element and a reference sample line indicated by the syntax element among a plurality of reference sample lines adjacent to the current block.

In the method for decoding the image, the syntax element may indicate one candidate in a candidate list including candidates indicating different combinations of intra prediction modes and reference sample lines used for intra prediction.

In the method for decoding the image, the intra prediction modes of the candidates may be intra prediction modes other than a predetermined mode.

In the method for decoding the image, the candidates of the candidate list may be a plurality of candidates that are selected based on a cost value of intra prediction based on a combination of an intra prediction mode and a reference sample line.

In the method for decoding the image, the cost value may be determined based on a comparison result between a result value of intra prediction based on the combination of the intra prediction mode and the reference e sample line and a prediction value corresponding to a template including samples adjacent to the current block.

In the method for decoding the image, the template may include samples of a reference sample line that is most adjacent to the current block.

In the method for decoding the image, the cost value may be measured through one method among a sum of absolute differences (SAD) measurement method, a sum of squared difference (SSD) measurement method, and a sum of absolute transformed differences.

In the method for decoding the image, the bin string may be a bin string binarized in a form of a truncated Golomb-Rice code, and the bin string may include a prefix and a suffix.

In the method for decoding the image, bins corresponding to the prefix of the bin string may be obtained by the arithmetic decoding, and bins corresponding to the suffix of the bin string may be obtained by the bypass decoding.

In the method for decoding the image, at least a portion of the bins corresponding to the prefix of the bin string and the bins corresponding to the suffix of the bin string may be obtained by the arithmetic decoding.

In the method for decoding the image, the bin string may be a bin string binarized in a form of a truncated unary code, and bins not exceeding a predetermined number in the bin string may be obtained by the arithmetic decoding.

A method for encoding an image according to an embodiment of the present invention includes deriving a syntax element indicating a combination of an intra prediction mode of a current block and a reference sample line used for intra prediction, generating a bin string by binarizing the syntax element, and generating a bitstream by encoding each bin of the bin string according to an encoding method corresponding to the each bin. Bypass coding may be applied to at least a portion of bins of the bin string, and arithmetic coding may be applied to a bin of the bin string other than the bins to which the bypass coding is applied.

A non-transitory computer-readable recording medium according to an embodiment of the present invention stores a bitstream generated by a method for encoding an image. The method for encoding the image may include deriving a syntax element indicating a combination of an intra prediction mode of a current block and a reference sample line used for intra prediction, generating a bin string by binarizing the syntax element, and generating a bitstream by encoding each bin of the bin string according to an encoding method corresponding to the each bin. Bypass coding may be applied to at least a portion of bins of the bin string, and arithmetic coding may be applied to a bin of the bin string other than the bins to which the bypass coding is applied.

A transmission method according to an embodiment of the present invention includes transmitting a bitstream generated by a method for encoding an image. The method for encoding the image includes deriving a syntax element indicating a combination of an intra prediction mode of a current block and a reference sample line used for intra prediction, generating a bin string by binarizing the syntax element, and generating a bitstream by encoding each bin of the bin string according to an encoding method corresponding to the each bin. Bypass coding may be applied to at least a portion of bins of the bin string, and arithmetic coding may be applied to a bin of the bin string other than the bins to which the bypass coding is applied.

The features briefly summarized above with respect to the present disclosure are provided as an example only to explain the detailed description and are not construed to limit the scope of the present disclosure.

### Advantageous Effects

According to the present invention, a method and apparatus for encoding/decoding an image with improved encoding/decoding efficiency may be provided.

In addition, according to the present invention, an entropy encoding/decoding method may be provided for a syntax element used for template-based multiple reference line (TMRL) intra prediction.

In addition, according to the present invention, an entropy encoding/decoding method may be provided for reducing the number of context-coded bins, when coding an index value for TMRL intra prediction, and thus for lowering complexity of an encoder/decoder without significant loss of coding efficiency and improving throughput.

Effects obtainable from the present disclosure are not limited to the above-mentioned effects, and other effects that are not mentioned will be clearly understood by those skilled in the art from the following description.

### DESCRIPTION OF DRAWINGS

FIG. 1 is a block diagram showing a configuration of an encoding apparatus according to an embodiment of the present invention.

FIG. 2 is a block diagram showing a configuration of a decoding apparatus according to an embodiment of the present invention.

FIG. 3 is a diagram schematically showing a video coding system to which the present invention is applicable.

FIG. 4 is a view for describing a CABAC encoding structure for a syntax element according to an embodiment of the present invention.

FIG. 5 is a view for describing a CABAC decoding structure for a syntax element according to an embodiment of the present invention.

FIG. 6 is a view for describing a template-based multiple reference line (TMRL) intra prediction method according to an embodiment of the present invention.

FIG. 7 is a view for describing intra template matching according to an embodiment of the present invention.

FIG. 8 is a flowchart showing an entropy decoding method according to an embodiment of the present invention.

FIG. 9 is a flowchart showing an entropy encoding method according to an embodiment of the present invention.

FIG. 10 is a view for illustrating a content streaming system to which an embodiment according to the present invention is applicable.

### MODE FOR INVENTION

The present disclosure may have various modifications and embodiments, and specific embodiments are illustrated in the drawings and described in detail in the detailed description. However, this is not intended to limit the present disclosure to specific embodiments, but should be understood to include all modifications, equivalents, or substitutes included in the spirit and technical scope of the present disclosure. Similar reference numerals in the drawings indicate the same or similar functions throughout various aspects. The shapes and sizes of elements in the drawings may be provided by way of example for a clearer description. The detailed description of the exemplary embodiments described below refers to the accompanying drawings, which illustrate specific embodiments by way of example. These embodiments are described in sufficient detail to enable those skilled in the art to practice the embodiments. It should be understood that the various embodiments are different from each other, but are not necessarily mutually exclusive. For example, specific shapes, structures, and characteristics described herein may be implemented in other embodiments without departing from the spirit and scope of the present disclosure with respect to one embodiment. It should also be understood that the positions or arrangements of individual components within each disclosed embodiment may be changed without departing from the spirit and scope of the embodiment. Accordingly, the detailed description set forth below is not intended to be limiting, and the scope of the exemplary embodiments is defined only by the appended claims, along with the full scope of equivalents to which such claims are entitled, if properly described.

In the present disclosure, the terms first, second, etc. may be used to describe various components, but the components should not be limited by the terms. The terms are only used for the purpose of distinguishing one component from another. For example, without departing from the scope of the present disclosure, the first component may be referred to as the second component, and similarly, the second component may also be referred to as the first component. The term is and/or includes a combination of a plurality of related described items or any item among a plurality of related described items.

The components shown in the embodiments of the present disclosure are independently depicted to indicate different characteristic functions, and do not mean that each component is formed as a separate hardware or software configuration unit. That is, each component is listed and included as a separate component for convenience of explanation, and at least two of the components may be combined to form a single component, or one component may be divided into multiple components to perform a function, and embodiments in which components are integrated and embodiments in which each component is divided are also included in the scope of the present disclosure as long as they do not deviate from the essence of the present disclosure.

The terminology used in the present disclosure is only used to describe specific embodiments and is not intended to limit the present disclosure. The singular expression includes the plural expression unless the context clearly indicates otherwise. In addition, some components of the present disclosure are not essential components that perform essential functions in the present disclosure and may be optional components only for improving performance. The present disclosure may be implemented by including only essential components for implementing the essence of the present disclosure excluding components only used for improving performance, and a structure including only essential components excluding optional components only used for improving performance is also included in the scope of the present disclosure.

In an embodiment, the term “at least one” may mean one of a number greater than or equal to 1, such as 1, 2, 3, and 4. In an embodiment, the term “a plurality of” may mean one of a number greater than or equal to 2, such as 2, 3, and 4.

Hereinafter, embodiments of the present disclosure will be specifically described with reference to the drawings. In describing the embodiments of this specification, if it is determined that a detailed description of a related known configuration or function may obscure the subject matter of this specification, the detailed description will be omitted, and the same reference numerals will be used for the same components in the drawings, and repeated descriptions of the same components will be omitted.

### Description of Terms

Hereinafter, “image” may mean one picture constituting a video, and may also refer to the video itself. For example, “encoding and/or decoding of an image” may mean “encoding and/or decoding of a video,” and may also mean “encoding and/or decoding of one of images constituting the video.”

Hereinafter, “moving image” and “video” may be used with the same meaning and may be used interchangeably. In addition, a target image may be an encoding target image that is a target of encoding and/or a decoding target image that is a target of decoding. In addition, the target image may be an input image input to an encoding apparatus and may be an input image input to a decoding apparatus. Here, the target image may have the same meaning as a current image.

Hereinafter, encoder and image encoding apparatus may be used with the same meaning and may be used interchangeably.

Hereinafter, decoder and image decoding apparatus may be used with the same meaning and may be used interchangeably.

Hereinafter, “image”, “picture”, “frame” and “screen” may be used with the same meaning and may be used interchangeably.

Hereinafter, a “target block” may be an encoding target block that is a target of encoding and/or a decoding target block that is a target of decoding. In addition, the target block may be a current block that is a target of current encoding and/or decoding. For example, “target block” and “current block” may be used with the same meaning and may be used interchangeably.

Hereinafter, “block” and “unit” may be used with the same meaning and may be used interchangeably. In addition, “unit” may mean including a luma component block and a chroma component block corresponding thereto in order to distinguish it from a block. For example, a coding tree unit (CTU) may be composed of one luma component (Y) coding tree block (CTB) and two chroma component (Cb, Cr) coding tree blocks related to it.

Hereinafter, “sample”, “picture element” and “pixel” may be used with the same meaning and may be used interchangeably. Herein, a sample may represent a basic unit that constitutes a block.

Hereinafter, “inter” and “inter-screen” may be used with the same meaning and can be used interchangeably.

Hereinafter, “intra” and “in-screen” may be used with the same meaning and can be used interchangeably.

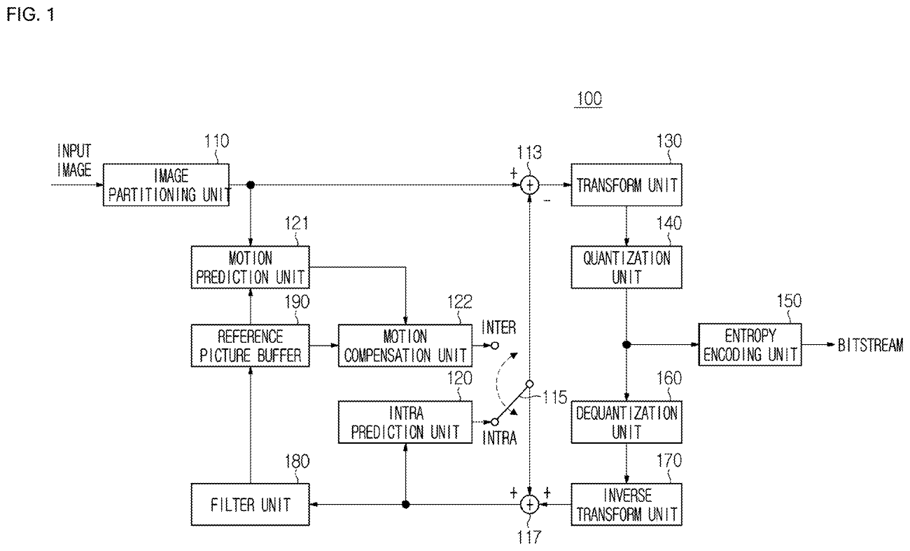

FIG. 1 is a block diagram showing a configuration of an encoding apparatus according to an embodiment of the present disclosure.

The encoding apparatus 100 may be an encoder, a video encoding apparatus, or an image encoding apparatus. A video may include one or more images. The encoding apparatus 100 may sequentially encode one or more images.

Referring to FIG. 1, the encoding apparatus 100 may include an image partitioning unit 110, an intra prediction unit 120, a motion prediction unit 121, a motion compensation unit 122, a switch 115, a subtractor 113, a transform unit 130, a quantization unit 140, an entropy encoding unit 150, a dequantization unit 160, an inverse transform unit 170, an adder 117, a filter unit 180 and a reference picture buffer 190.

In addition, the encoding apparatus 100 may generate a bitstream including information encoded through encoding of an input image, and output the generated bitstream. The generated bitstream may be stored in a computer-readable recording medium, or may be streamed through a wired/wireless transmission medium.

The image partitioning unit 110 may partition the input image into various forms to increase the efficiency of video encoding/decoding. That is, the input video is composed of multiple pictures, and one picture may be hierarchically partitioned and processed for compression efficiency, parallel processing, etc. For example, one picture may be partitioned into one or multiple tiles or slices, and then partitioned again into multiple CTUs (Coding Tree Units). Alternatively, one picture may first be partitioned into multiple sub-pictures defined as groups of rectangular slices, and each sub-picture may be partitioned into the tiles/slices. Here, the sub-picture may be utilized to support the function of partially independently encoding/decoding and transmitting the picture. Since multiple sub-pictures may be individually reconstructed, it has the advantage of easy editing in applications that configure multi-channel inputs into one picture. In addition, a tile may be divided horizontally to generate bricks. Here, the brick may be utilized as the basic unit of parallel processing within the picture. In addition, one CTU may be recursively partitioned into quad trees (QTs), and the terminal node of the partition may be defined as a CU (Coding Unit). The CU may be partitioned into a PU (Prediction Unit), which is a prediction unit, and a TU (Transform Unit), which is a transform unit, to perform prediction and partition. Meanwhile, the CU may be utilized as the prediction unit and/or the transform unit itself. Here, for flexible partition, each CTU may be recursively partitioned into multi-type trees (MTTs) as well as quad trees (QTs). The partition of the CTU into multi-type trees may start from the terminal node of the QT, and the MTT may be composed of a binary tree (BT) and a triple tree (TT). For example, the MTT structure may be classified into a vertical binary split mode (SPLIT_BT_VER), a horizontal binary split mode (SPLIT_BT_HOR), a vertical ternary split mode (SPLIT_TT_VER), and a horizontal ternary split mode (SPLIT_TT_HOR). In addition, a minimum block size (MinQTSize) of the quad tree of the luma block during partition may be set to 16×16, a maximum block size (MaxBtSize) of the binary tree may be set to 128×128, and a maximum block size (MaxTtSize) of the triple tree may be set to 64×64. In addition, a minimum block size (MinBtSize) of the binary tree and a minimum block size (MinTtSize) of the triple tree may be specified as 4×4, and the maximum depth (MaxMttDepth) of the multi-type tree may be specified as 4. In addition, in order to increase the encoding efficiency of the I slice, a dual tree that differently uses CTU partition structures of luma and chroma components may be applied. On the other hand, in P and B slices, the luma and chroma CTBs (Coding Tree Blocks) within the CTU may be partitioned into a single tree that shares the coding tree structure.

The encoding apparatus 100 may perform encoding on the input image in the intra mode and/or the inter mode. Alternatively, the encoding apparatus 100 may perform encoding on the input image in a third mode (e.g., IBC mode, Palette mode, etc.) other than the intra mode and the inter mode. However, if the third mode has functional characteristics similar to the intra mode or the inter mode, it may be classified as the intra mode or the inter mode for convenience of explanation. In the present disclosure, the third mode will be classified and described separately only when a specific description thereof is required.

When the intra mode is used as the prediction mode, the switch 115 may be switched to intra, and when the inter mode is used as the prediction mode, the switch 115 may be switched to inter. Here, the intra mode may mean an intra prediction mode, and the inter mode may mean an inter prediction mode. The encoding apparatus 100 may generate a prediction block for an input block of the input image. In addition, the encoding apparatus 100 may encode a residual block using a residual of the input block and the prediction block after the prediction block is generated. The input image may be referred to as a current image which is a current encoding target. The input block may be referred to as a current block which is a current encoding target or an encoding target block.

When a prediction mode is an intra mode, the intra prediction unit 120 may use a sample of a block that has been already encoded/decoded around a current block as a reference sample. The intra prediction unit 120 may perform spatial prediction for the current block by using the reference sample, or generate prediction samples of an input block through spatial prediction.

Herein, the intra prediction may mean in-screen prediction.

As an intra prediction method, non-directional prediction modes such as DC mode and Planar mode and directional prediction modes (e.g., 65 directions) may be applied. Here, the intra prediction method may be expressed as an intra prediction mode or an in-screen prediction mode.

When a prediction mode is an inter mode, the motion prediction unit 121 may retrieve a region that best matches with an input block from a reference image in a motion prediction process, and derive a motion vector by using the retrieved region. In this case, a search region may be used as the region. The reference image may be stored in the reference picture buffer 190. Here, when encoding/decoding for the reference image is performed, it may be stored in the reference picture buffer 190.

The motion compensation unit 122 may generate a prediction block of the current block by performing motion compensation using a motion vector. Herein, inter prediction may mean inter-screen prediction or motion compensation.

When the value of the motion vector is not an integer, the motion prediction unit 121 and the motion compensation unit 122 may generate the prediction block by applying an interpolation filter to a partial region of the reference picture. In order to perform inter prediction or motion compensation, it may be determined whether the motion prediction and motion compensation mode of the prediction unit included in the coding unit is one of a skip mode, a merge mode, an advanced motion vector prediction (AMVP) mode, and an intra block copy (IBC) mode based on the coding unit and inter prediction or motion compensation may be performed according to each mode.

In addition, based on the above inter prediction method, an AFFINE mode of sub-PU based prediction, an SbTMVP (Subblock-based Temporal Motion Vector Prediction) mode, an MMVD (Merge with MVD) mode of PU-based prediction, and a GPM (Geometric Partitioning Mode) mode may be applied. In addition, in order to improve the performance of each mode, HMVP (History based MVP), PAMVP (Pairwise Average MVP), CIIP (Combined Intra/Inter Prediction), AMVR (Adaptive Motion Vector Resolution), BDOF (Bi-Directional Optical-Flow), BCW (Bi-predictive with CU Weights), LIC (Local Illumination Compensation), TM (Template Matching), OBMC (Overlapped Block Motion Compensation), etc. may be applied.

Among these, the AFFINE mode is a technology that is used in both AMVP and MERGE modes and also has high encoding efficiency. In the existing video coding standard, since MC (Motion Compensation) is performed by considering only the parallel movement of blocks, it has a disadvantage in that it cannot properly compensate for motions that occur in reality, such as zoom-in/out and rotation. To supplement this, a four-parameter affine motion model using two control point motion vectors (CPMVs) and a six-parameter affine motion model using three control point motion vectors may be used and applied to inter prediction. Here, CPMV is a vector representing the affine motion model of one of the upper left, upper right, and lower left of the current block.

The subtractor 113 may generate a residual block by using a difference between an input block and a prediction block. The residual block may be called a residual signal. The residual signal may mean a difference between an original signal and a prediction signal. Alternatively, the residual signal may be a signal generated by transforming or quantizing, or transforming and quantizing a difference between the original signal and the prediction signal. The residual block may be a residual signal of a block unit.

The transform unit 130 may generate a transform coefficient by performing transform on a residual block, and output the generated transform coefficient. Herein, the transform coefficient may be a coefficient value generated by performing transform on the residual block. When a transform skip mode is applied, the transform unit 130 may skip transform of the residual block.

A quantized level may be generated by applying quantization to the transform coefficient or to the residual signal.

Hereinafter, the quantized level may also be called a transform coefficient in embodiments.

For example, a 4×4 luma residual block generated through intra prediction is transformed using a base vector based on DST (Discrete Sine Transform), and transform may be performed on the remaining residual block using a base vector based on DCT (Discrete Cosine Transform). In addition, a transform block is partitioned into a quad tree shape for one block using RQT (Residual Quad Tree) technology, and after performing transform and quantization on each transformed block partitioned through RQT, a coded block flag (cbf) may be transmitted to increase encoding efficiency when all coefficients become 0.

As another alternative, the Multiple Transform Selection (MTS) technique, which selectively uses multiple transform bases to perform transform, may be applied. That is, instead of partitioning a CU into TUs through RQT, a function similar to TU partition may be performed through the sub-block Transform (SBT) technique. Specifically, SBT is applied only to inter prediction blocks, and unlike RQT, the current block may be partitioned into ½ or ¼ sizes in the vertical or horizontal direction and then transform may be performed on only one of the blocks. For example, if it is partitioned vertically, transform may be performed on the leftmost or rightmost block, and if it is partitioned horizontally, transform may be performed on the topmost or bottommost block.

In addition, LFNST (Low Frequency Non-Separable Transform), a secondary transform technique that additionally transforms the residual signal transformed into the frequency domain through DCT or DST, may be applied. LFNST additionally performs transform on the low-frequency region of 4×4 or 8×8 in the upper left, so that the residual coefficients may be concentrated in the upper left.

The quantization unit 140 may generate a quantized level by quantizing the transform coefficient or the residual signal according to a quantization parameter (QP), and output the generated quantized level. Herein, the quantization unit 140 may quantize the transform coefficient by using a quantization matrix.

For example, a quantizer using QP values of 0 to 51 may be used. Alternatively, if the image size is larger and high encoding efficiency is required, the QP of 0 to 63 may be used. Also, a DQ (Dependent Quantization) method using two quantizers instead of one quantizer may be applied. DQ performs quantization using two quantizers (e.g., Q0 and Q1), but even without signaling information about the use of a specific quantizer, the quantizer to be used for the next transform coefficient may be selected based on the current state through a state transition model.

The entropy encoding unit 150 may generate a bitstream by performing entropy encoding according to a probability distribution on values calculated by the quantization unit 140 or on coding parameter values calculated when performing encoding, and output the bitstream. The entropy encoding unit 150 may perform entropy encoding of information on a sample of an image and information for decoding an image. For example, the information for decoding the image may include a syntax element.

When entropy encoding is applied, symbols are represented so that a smaller number of bits are assigned to a symbol having a high occurrence probability and a larger number of bits are assigned to a symbol having a low occurrence probability, and thus, the size of bit stream for symbols to be encoded may be decreased. The entropy encoding unit 150 may use an encoding method, such as exponential Golomb, context-adaptive variable length coding (CAVLC), context-adaptive binary arithmetic coding (CABAC), etc., for entropy encoding. For example, the entropy encoding unit 150 may perform entropy encoding by using a variable length coding/code (VLC) table. In addition, the entropy encoding unit 150 may derive a binarization method of a target symbol and a probability model of a target symbol/bin, and perform arithmetic coding by using the derived binarization method, and a context model.

In relation to this, when applying CABAC, in order to reduce the size of the probability table stored in the decoding apparatus, a table probability update method may be changed to a table update method using a simple equation and applied. In addition, two different probability models may be used to obtain more accurate symbol probability values.

In order to encode a transform coefficient level (quantized level), the entropy encoding unit 150 change a two-dimensional block form coefficient into a one-dimensional vector form through a transform coefficient scanning method.

A coding parameter may include information (flag, index, etc.) encoded in the encoding apparatus 100 and signaled to the decoding apparatus 200, such as syntax element, and information derived in the encoding or decoding process, and may mean information required when encoding or decoding an image.

Herein, signaling the flag or index may mean that a corresponding flag or index is entropy encoded and included in a bitstream in an encoder, and may mean that the corresponding flag or index is entropy decoded from a bitstream in a decoder.

The encoded current image may be used as a reference image for another image to be processed later. Therefore, the encoding apparatus 100 may reconstruct or decode the encoded current image again and store the reconstructed or decoded image as a reference image in the reference picture buffer 190.

A quantized level may be dequantized in the dequantization unit 160, or may be inversely transformed in the inverse transform unit 170. A dequantized and/or inversely transformed coefficient may be added with a prediction block through the adder 117. Herein, the dequantized and/or inversely transformed coefficient may mean a coefficient on which at least one of dequantization and inverse transform is performed, and may mean a reconstructed residual block. The dequantization unit 160 and the inverse transform unit 170 may be performed as an inverse process of the quantization unit 140 and the transform unit 130.

The reconstructed block may pass through the filter unit 180. The filter unit 180 may apply all or some filtering techniques among a deblocking filter, a sample adaptive offset (SAO), an adaptive loop filter (ALF), a bilateral filter (BIF), luma mapping with chroma scaling (LMCS), etc. to a reconstructed sample, a reconstructed block or a reconstructed image. The filter unit 180 may be called an in-loop filter. In this case, the in-loop filter is also used as name excluding LMCS.

The deblocking filter may remove block distortion generated in boundaries between blocks. In order to determine whether or not to apply a deblocking filter, whether or not to apply a deblocking filter to a current block may be determined based on samples included in several rows or columns which are included in the block. When a deblocking filter is applied to a block, a different filter may be applied according to a required deblocking filtering strength.

In order to compensate for encoding error using sample adaptive offset, a proper offset value may be added to a sample value. The sample adaptive offset may correct an offset of a deblocked image from an original image by a sample unit. A method of partitioning a sample included in an image into a predetermined number of regions, determining a region to which an offset is applied, and applying the offset to the determined region, or a method of applying an offset in consideration of edge information on each sample may be used.

A bilateral filter (BIF) may also correct the offset from the original image on a sample-by-sample basis for the image on which deblocking has been performed.

The adaptive loop filter may perform filtering based on a comparison result of the reconstructed image and the original image. Samples included in an image may be partitioned into predetermined groups, a filter to be applied to each group may be determined, and differential filtering may be performed for each group. Information of whether or not to apply the ALF may be signaled by coding units (CUs), and a form and coefficient of the adaptive loop filter to be applied to each block may vary.

In LMCS (Luma Mapping with Chroma Scaling), luma mapping (LM) means remapping luma values through a piece-wise linear model, and chroma scaling (CS) means a technique for scaling the residual value of the chroma component according to the average luma value of the prediction signal. In particular, LMCS may be utilized as an HDR correction technique that reflects the characteristics of HDR (High Dynamic Range) images.

The reconstructed block or the reconstructed image having passed through the filter unit 180 may be stored in the reference picture buffer 190. A reconstructed block that has passed through the filter unit 180 may be a part of a reference image. That is, the reference image is a reconstructed image composed of reconstructed blocks that have passed through the filter unit 180. The stored reference image may be used later in inter prediction or motion compensation.

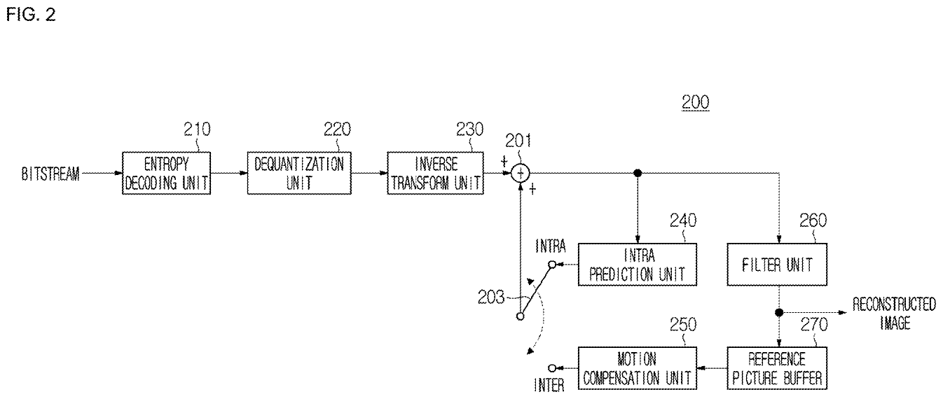

FIG. 2 is a block diagram showing a configuration of a decoding apparatus according to an embodiment of the present disclosure.

A decoding apparatus 200 may a decoder, a video decoding apparatus, or an image decoding apparatus.

Referring to FIG. 2, the decoding apparatus 200 may include an entropy decoding unit 210, a dequantization unit 220, an inverse transform unit 230, an intra prediction unit 240, a motion compensation unit 250, an adder 201, a switch 203, a filter unit 260, and a reference picture buffer 270.

The decoding apparatus 200 may receive a bitstream output from the encoding apparatus 100. The decoding apparatus 200 may receive a bitstream stored in a computer-readable recording medium, or may receive a bitstream that is streamed through a wired/wireless transmission medium. The decoding apparatus 200 may decode the bitstream in an intra mode or an inter mode. In addition, the decoding apparatus 200 may generate a reconstructed image generated through decoding or a decoded image, and output the reconstructed image or decoded image.

When a prediction mode used for decoding is an intra mode, the switch 203 may be switched to intra. Alternatively, when a prediction mode used for decoding is an inter mode, the switch 203 may be switched to inter.

The decoding apparatus 200 may obtain a reconstructed residual block by decoding the input bitstream, and generate a prediction block. When the reconstructed residual block and the prediction block are obtained, the decoding apparatus 200 may generate a reconstructed block that becomes a decoding target by adding the reconstructed residual block and the prediction block. The decoding target block may be called a current block.

The entropy decoding unit 210 may generate symbols by entropy decoding the bitstream according to a probability distribution. The generated symbols may include a symbol of a quantized level form. Herein, an entropy decoding method may be an inverse process of the entropy encoding method described above.

The entropy decoding unit 210 may change a one-dimensional vector-shaped coefficient into a two-dimensional block-shaped coefficient through a transform coefficient scanning method to decode a transform coefficient level (quantized level).

A quantized level may be dequantized in the dequantization unit 220, or inversely transformed in the inverse transform unit 230. The quantized level may be a result of dequantization and/or inverse transform, and may be generated as a reconstructed residual block. Herein, the dequantization unit 220 may apply a quantization matrix to the quantized level. The dequantization unit 220 and the inverse transform unit 230 applied to the decoding apparatus may apply the same technology as the dequantization unit 160 and inverse transform unit 170 applied to the aforementioned encoding apparatus.

When an intra mode is used, the intra prediction unit 240 may generate a prediction block by performing, on the current block, spatial prediction that uses a sample value of a block which has been already decoded around a decoding target block. The intra prediction unit 240 applied to the decoding apparatus may apply the same technology as the intra prediction unit 120 applied to the aforementioned encoding apparatus.

When an inter mode is used, the motion compensation unit 250 may generate a prediction block by performing, on the current block, motion compensation that uses a motion vector and a reference image stored in the reference picture buffer 270. The motion compensation unit 250 may generate a prediction block by applying an interpolation filter to a partial region within a reference image when the value of the motion vector is not an integer value. In order to perform motion compensation, it may be determined whether the motion compensation method of the prediction unit included in the corresponding coding unit is a skip mode, a merge mode, an AMVP mode, or a current picture reference mode based on the coding unit, and motion compensation may be performed according to each mode. The motion compensation unit 250 applied to the decoding apparatus may apply the same technology as the motion compensation unit 122 applied to the encoding apparatus described above.

The adder 201 may generate a reconstructed block by adding the reconstructed residual block and the prediction block. The filter unit 260 may apply at least one of inverse-LMCS, a deblocking filter, a sample adaptive offset, and an adaptive loop filter to the reconstructed block or reconstructed image. The filter unit 260 applied to the decoding apparatus may apply the same filtering technology as that applied to the filter unit 180 applied to the aforementioned encoding apparatus.

The filter unit 260 may output the reconstructed image. The reconstructed block or reconstructed image may be stored in the reference picture buffer 270 and used for inter prediction. A reconstructed block that has passed through the filter unit 260 may be a part of a reference image. That is, a reference image may be a reconstructed image composed of reconstructed blocks that have passed through the filter unit 260. The stored reference image may be used later in inter prediction or motion compensation.

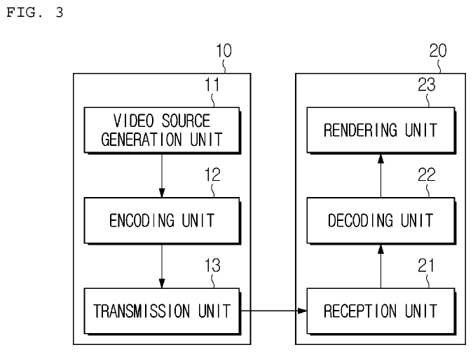

FIG. 3 is a diagram schematically showing a video coding system to which the present disclosure is applicable.

A video coding system according to an embodiment may include an encoding apparatus 10 and a decoding apparatus 20. The encoding apparatus 10 may transmit encoded video and/or image information or data to the decoding apparatus 20 in the form of a file or streaming through a digital storage medium or a network.

The encoding apparatus 10 according to an embodiment may include a video source generation unit 11, an encoding unit 12, and a transmission unit 13. The decoding apparatus 20 according to an embodiment may include a reception unit 21, a decoding unit 22, and a rendering unit 23. The encoding unit 12 may be called a video/image encoding unit, and the decoding unit 22 may be called a video/image decoding unit. The transmission unit 13 may be included in the encoding unit 12. The reception unit 21 may be included in the decoding unit 22. The rendering unit 23 may include a display unit, and the display unit may be configured as a separate device or an external component.

The video source generation unit 11 may obtain the video/image through a process of capturing, synthesizing, or generating the video/image. The video source generation unit 11 may include a video/image capture device and/or a video/image generation device. The video/image capture device may include, for example, one or more cameras, a video/image archive including previously captured video/image, etc. The video/image generation device may include, for example, a computer, a tablet, and a smartphone, etc., and may (electronically) generate the video/image. For example, a virtual video/image may be generated through a computer, etc., in which case the video/image capture process may be replaced with a process of generating related data.

The encoding unit 12 may encode the input video/image. The encoding unit 12 may perform a series of procedures such as prediction, transform, for compression and encoding efficiency. The encoding unit 12 may output encoded data (encoded video/image information) in the form of a bitstream. The detailed configuration of the encoding unit 12 may also be configured in the same manner as the encoding apparatus 100 of FIG. 1 described above.

The transmission unit 13 may transmit encoded video/image information or data output in the form of a bitstream to the reception unit 21 of the decoding apparatus 20 through a digital storage medium or a network in the form of a file or streaming. The digital storage medium may include various storage media such as USB, SD, CD, DVD, Blu-ray, HDD, SSD, etc. The transmission unit 13 may include an element for generating a media file through a predetermined file format and may include an element for transmission through a broadcasting/communication network. The reception unit 21 may extract/receive the bitstream from the storage medium or the network and transmit it to the decoding unit 22.

The decoding unit 22 may decode the video/image by performing a series of procedures such as dequantization, inverse transform, and prediction corresponding to the operation of the encoding unit 12. The detailed configuration of the decoding unit 22 may also be configured in the same manner as the above-described decoding apparatus 200 of FIG. 2.

The rendering unit 23 may render the decoded video/image. The rendered video/image may be displayed through the display unit.

In other words, an encoder may perform entropy encoding for information for decoding an image, which includes a syntax element and the like, generate and transmit a bitstream. For entropy encoding, the encoder may use an encoding method such as CABAC.

In addition, a decoder may obtain the bitstream and decode the bitstream by using a decoding method such as CABAC. In addition, the decoder may obtain information for decoding of a decoding target block based on a decoding result of the bitstream and may generate a prediction block of the decoding target block.

A CABAC encoding structure of an encoding apparatus and a CABAC decoding structure of a decoding apparatus are each described below.

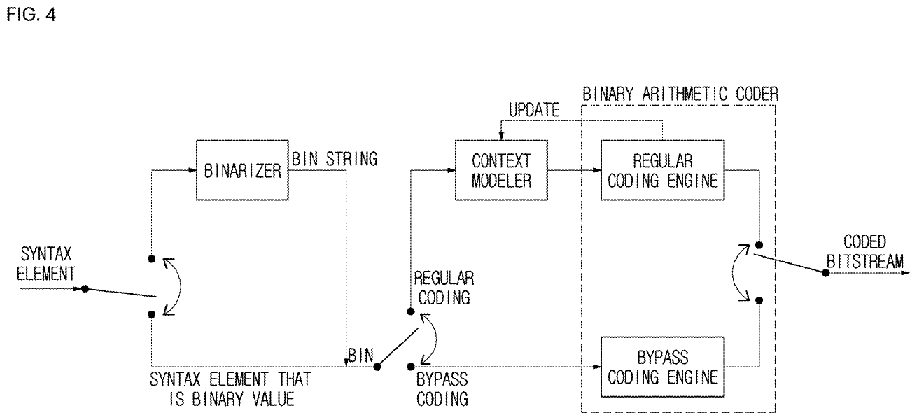

FIG. 4 is a view for describing a CABAC encoding structure for a syntax element according to an embodiment of the present invention.

Referring to FIG. 4, the CABAC encoding structure includes a binarization structure that binarizes syntax elements to generate bins or a bin string, and a binary arithmetic coder structure that encodes the bins or bin string. In addition, the binary arithmetic coder may include a regular coding engine based on a context model of a context modeler and a bypass coding engine. Herein, the regular coding engine may be an arithmetic coding structure.

When a syntax element is already a binary value, the CABAC encoding structure may not perform further binarization for the syntax element but may use the value of the syntax element as it is. On the other hand, when a syntax element is not a binary value, the CABAC encoding structure may binarize a value of the syntax element, which is not a binary value, to convert the value into a binary value. Each binary digit 0 or 1 constituting a binary value is defined as a bin. In addition, a structure in which a plurality of bins are arranged is defined as a bin string. For example, when a bin string after binarization is 110, each of 1, 1, and 0 is referred to as a bin.

Bins or bin string of a binarized syntax element may be subject to regular coding or bypass coding according to an encoding method corresponding to each bin. Herein, regular coding may be context model-based binary arithmetic coding (CABAC). In a regular coding process, a context model reflecting a probability value for a bin may be assigned. In addition, the bin may be encoded based on the assigned context model. In the regular coding process, encoding may be performed for a bin, and a context model for the bin may be updated. Thus, a bin that is regular-coded by a regular coding engine is referred to as a context-coded bin.

On the other hand, unlike the regular coding process, a bypass coding process may be a coding process that omits a process of estimating a probability of an input bin and a process of updating a context model that is applied to a bin. Instead of assigning a context model to a bin, the bypass coding process may encode a bin by applying a uniform (or fixed) probability distribution. Thus, the speed of entropy encoding may be improved. As described above, a bin that is bypass-coded by a bypassing coding engine is referred to as a bypass-coded bin.

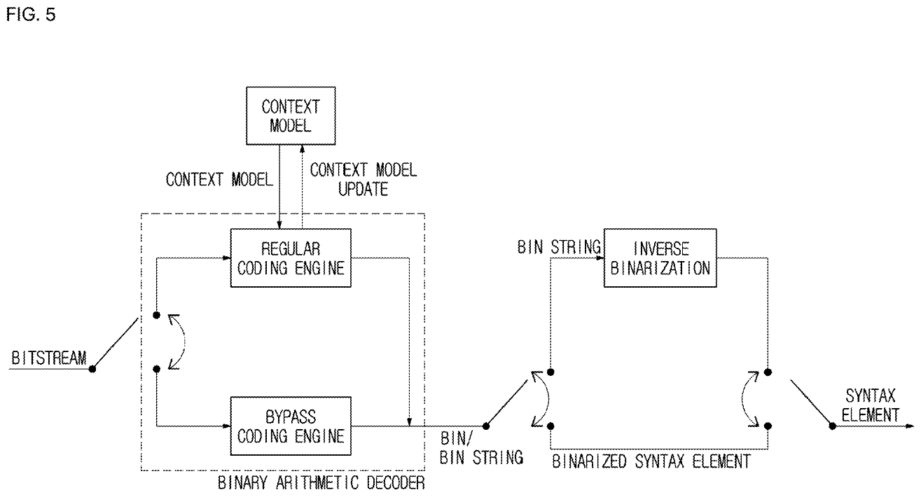

FIG. 5 is a view for describing a CABAC decoding structure for a syntax element according to an embodiment of the present invention.

Referring to FIG. 5, the CABAC decoding structure includes a binary arithmetic decoder structure that decodes a bitstream to obtain bins or a bin string corresponding to a syntax element, and an inverse binarization structure that inverse-binarizes the bins or bin string to output the syntax element. In addition, the binary arithmetic decoder may include a regular coding engine based on a context model and a bypass coding engine. Herein, the regular coding engine may be a context model-based binary arithmetic coding structure.

Entropy decoding may be a process of performing the above-described entropy encoding process in reverse order. For example, when a syntax element is encoded based on a context model, a decoder may obtain bins or a bin string corresponding to the syntax element from a received bitstream. The decoder may determine a context model of the bins or a bin string by using at least one of a syntax element, a decoding target block, decoding information of a neighboring block, or information on a syntax element/bin that is decoded in a previous step. In addition, the decoder may predict an occurrence probability of the obtained bins according to the context model, perform arithmetic decoding, and thus derive a value of the bins or bin string corresponding to the syntax element. A context model of a bin, which is decoded later, may be updated based on a context model that is determined through the above-described process.

When a syntax element is bypass-decoded, the decoder may obtain bins or a bin string corresponding to the syntax element through a bitstream and may decode the bins or bin string by applying a uniform (or fixed) distribution to the obtained bins. In addition, a procedure of deriving a context model of a syntax element and a procedure of updating a context model applied to bins after decoding may be omitted.

When a decoded syntax element is a bin string, the decoder may obtain the syntax element by inverse-binarizing the bin string. On the other hand, when a decoded syntax element is one bin, the decoder may omit an inverse binarization process and use a bin value itself as a value of the syntax element.

Herein, the syntax element may include a syntax element related to intra prediction and a syntax element related to inter prediction. In addition, according to an embodiment of the present invention, the syntax element related to intra prediction may be a syntax element related to template-based multiple reference line (TMRL) intra prediction.

TMRL intra prediction may be intra prediction based on a method of combining and signaling an intra prediction mode of a block and a reference sample line used for intra prediction of the block. An embodiment of a TMRL intra prediction method may be described as follows.

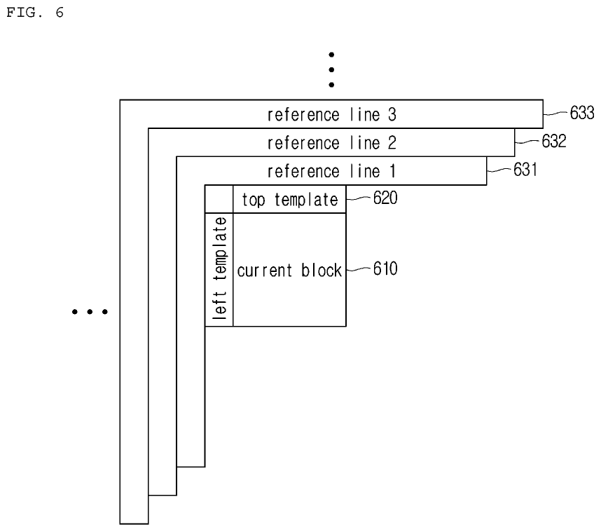

FIG. 6 is a view for describing a template-based multiple reference line (TMRL) intra prediction method according to an embodiment of the present invention.

Referring to FIG. 6, TMRL intra prediction may be performed by using an intra prediction mode for a current block 610 and N multiple reference samples. The number of intra prediction modes used for TMRL intra prediction may be M. Herein, M is a positive integer that is equal to or greater than 1. Among intra prediction modes, an preset arbitrary mode in an encoder/decoder may not be used for TMRL intra prediction. According to an embodiment, the preset arbitrary mode may be the planar mode or a non-directional prediction mode.

In addition, referring to FIG. 6, a plurality of sample lines 620, 631, 632, 633 used for TMRL intra prediction are illustrated. Herein, a neighboring sample line (reference line 0, 620) nearest to a current block may be used as a template, and next N nearest reference sample lines 631, 632, 633 may be used as multiple reference sample lines. Herein, N is a positive integer that is equal to or greater than 2.

A total number of combinations of N reference sample lines 631, 632, 633 and M intra prediction modes is N×M. In addition, for TMRL intra prediction, a candidate list including candidates indicating different combinations of intra prediction modes and reference sample lines used for intra prediction may be generated.

According to an embodiment, a candidate list for TMRL intra prediction may use all N×M combinations. On the other hand, according to another embodiment, the candidate list for TMRL intra prediction may include only K candidates that are determined based on cost value of an intra prediction value based on the combination of intra prediction modes and reference sample lines. Herein, the cost value may be a result value of a cost function based on a comparison result between a prediction value using a template derived from template matching and an intra prediction value using the combination of the intra prediction modes and the reference sample lines.

Herein, K candidates may be K candidates having a lowest cost value among N×M combinations. In addition, K candidates may be arranged in a predetermined order (e.g., in ascending order of cost values) to constitute the candidate list. Herein, K may be an integer that is equal to or greater than 1 and equal to or less than N×M.

Herein, the cost function may use at least one method of the sum of absolute difference (SAD), the sum of squared difference (SSD), and the sum of absolute transformed differences (SATD).

Herein, the template matching for calculating the cost value may be described as follows.

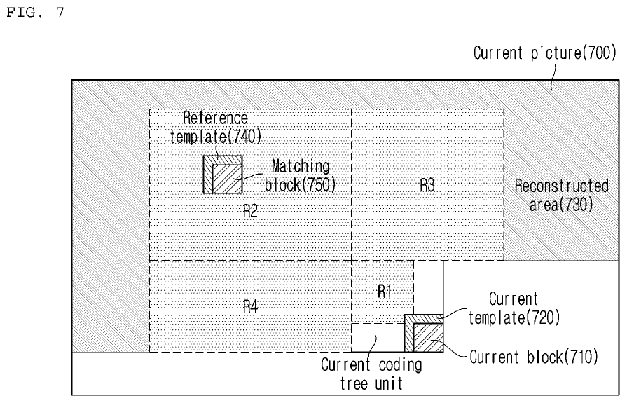

FIG. 7 is a view for describing intra template matching according to an embodiment of the present invention.

Referring to FIG. 7, based on a current block 710, intra template matching prediction may determine an optimal prediction block for the current block in a reconstructed area 730 within a current picture 700. Specifically, in intra template matching prediction, a set of neighboring adjacent reference samples of the current coding block 710 may be defined as a current template 720. In addition, a matching block 750 may be determined by searching for a reference template 740 with highest similarity to the current template 720 through template matching-based search performed within the reconstructed area 730 based on the current template 720. Herein, the matching block 750 may be used as a prediction block for the current block 710.

Meanwhile, template matching-based search may be performed in predefined regions R1, R2, R3 and R4 in the reconstructed area 730, and the search may be performed in the order of R1, R2, R3 and R4.

That is, the reference template 740, which has highest similarity to the L-shaped current template 720 adjacent to the current block, is searched in a search region, and a block adjacent to the reference template 740 is determined as a matching block. However, a template may have a shape other than L-shape. For example, a template having a shape other than the L-shape may be a left template including neighboring samples on the left side of the block, or an upper template including neighboring samples on the upper side of the block.

Alternatively, when template matching is performed, a template may be a template with a shape that is implicitly determined, among an L-shaped template, a left template, an upper template, based on the size and location of a current block or templates with various shapes using neighboring samples of the block that are predefined in an encoder or a decoder.

In TMRL intra prediction, an index value of a candidate in a constructed candidate list, which indicates a combination of a reference line used for intra prediction of a current block and an intra prediction mode, may be signaled. An index of a candidate indicating a combination of a reference line used for intra prediction of a current block and an intra prediction mode may be referred to as a TMRL index. A value of a TMRL index may be entropy-encoded through context-based adaptive binary arithmetic coding (CABAC).

A value of a TMRL index may not be a binary value. Accordingly, a TMRL index may be binarized before being entropy-encoded. For example, a TMRL index may be binarized by a truncated Golomb-Rice code method. Indexes of candidates included in a candidate list used for TMRL intra prediction may be expressed by codewords that are binarized by the truncated Golomb-Rice code method, as shown below.

TABLE 1

| Index | Prefix | Suffix |
|---|---|---|
| 0 | 0 | 00 |
| 1 | 0 | 01 |
| 2 | 0 | 10 |
| 3 | 0 | 11 |
| 4 | 10 | 00 |
| . . . | . . . | . . . |
| 18 | 1111 | 10 |
| 19 | 1111 | 11 |

However, the embodiment of Table 1 is merely one embodiment in which indexes of candidates included in a candidate list used for TMRL intra prediction are expressed in codeword forms. Indexes of candidates included in a candidate list used for TMRL intra prediction may be binarized by using various binarization methods (e.g., truncated unary code).

However, when CABAC encoding is applied to a TMRL index, an encoding process may be delayed due to a context model updating (or probability updating) process of regular coding. For example, when two bins that are subjected to regular coding use a same context model, a value of a first bin may affect a probability model. Accordingly, before a second bin is coded, a context (or probability) value that has been modified by the value of the first bin needs to be updated. The context (or probability) updating process may cause a delay in a coding cycle. That is, repeatedly invoking a same context and awaiting the update of a context (or probability) model after coding each bin may cause a bottleneck in an encoder/decoder, and may decrease the throughput of encoding and decoding. In addition, even when bins exhibiting low correlation are regular-coded, the performance gain may be small or negligible compared with the regular coding of bins having higher correlation.

Accordingly, for efficient entropy encoding of a TMRL index, one of the following methods may be used.

According to an embodiment of the present invention, the amount of time and computational resources saved by performing regular coding on only a portion of the bins of a bin string corresponding to a TMRL index may be more significant than the coding performance obtained by performing regular coding on all the bins of the bin string corresponding to the TMRL index. Accordingly, an encoder may encode a bin string corresponding to a TMRL index by combining regular coding and bypass coding. To this end, the encoder may encode one or more bins of the bin string corresponding to the TMRL index in context coding bins (that is, regular coding) and encode the remaining bins of the bin string corresponding to the TMRL index in bypass coding bins (that is, bypass coding).

Correspondingly, a decoder may use a regular coding engine to decode one or more context-coded bins in the bin string corresponding to the TMRL index. In addition, the decoder may use a bypass coding engine to decode the remaining non-context-coded bins in the bin string corresponding to the TMRL index.

Specifically, according to an embodiment of the present invention, when a TMRL index is binarized in the form of a codeword distinguished into a prefix and a suffix as shown in Table 1, regular coding may be applied to bins corresponding to the prefix of the codeword, and bypass coding may be applied to bins corresponding to the suffix of the codeword. That is, the bins corresponding to the prefix of the codeword may be context-coded bins, and the bins corresponding to the suffix of the codeword may be bypass-coded bins.

According to another embodiment of the present invention, the bins corresponding to the suffix of the TMRL index may be distinguished into two or more groups. Table 2 is an embodiment in which indexes of a candidate list composed of 20 candidates are binarized in the form of a codeword by the truncated Golomb-Rice code method and bins corresponding to the suffixes of codewords are distinguished into two groups.

TABLE 2

| Index | Prefix | Suffix0 | Suffix1 |
|---|---|---|---|
| 0 | 0 | 0 | 0 |
| 1 | 0 | 0 | 1 |
| 2 | 0 | 1 | 0 |
| 3 | 0 | 1 | 1 |
| 4 | 10 | 0 | 0 |
| . . . | . . . | . . . | . . . |
| 18 | 1111 | 1 | 0 |
| 19 | 1111 | 1 | 1 |

In addition, among bins corresponding to the suffix of codewords, bypass coding may be applied to bins of a group (or some groups), and context coding may be applied to the remaining bins.

According to an embodiment of the present invention, an encoder may apply bypass coding only to a bin corresponding to a suffix 1 of a codeword in Table 2 and apply context coding to bins corresponding to the prefix and a suffix 0. Alternatively, the encoder may apply bypass coding only to suffix 0 and apply context coding to bins corresponding to the prefix and suffix 1.

That is, bins corresponding to the prefix of the codewords and a group of the suffixes may be context-coded bins, and bins corresponding to the remaining group of the suffix of the codeword may be bypass-coded bins.

According to still another embodiment of the present invention, a binary coding method (e.g., truncated unary code) may be used to binarize a TMRL index into a codeword form that has neither a prefix nor a suffix. When a TMRL index is binarized into a codeword form without a prefix and a suffix, a maximum number of context coding bins for TMRL index coding may be determined in advance. An encoder may apply context coding to a predetermined number of bins in codewords of TMRL index. On the other hand, the encoder may apply context coding to bins exceeding the predetermined number in the codewords of TMRL indexes. That is, the predetermined number of bins in the codewords may be context-coded bins, and the bins exceeding the predetermined number of bins in the codewords may be bypass-coded bins.

According to still another embodiment of the present invention, bins of a bin string corresponding to a TMRL index may not have high correlation. In this case, for the bins of the bin string corresponding to the TMRL index, there is no significant difference in coding performance between regular coding and bypass coding. In other words, regular coding of the bins of the bin string corresponding to the TMRL index may only result in a bottleneck and may have little significance in terms of coding performance.

In addition, in some applications, when entropy coding bins of a bin string corresponding to a TMRL index, the amount of time and computational resources saved by performing bypass coding on all the bins of the bin string may be more important than the coding performance obtained by performing regular coding on all the bins of the bin string.

Accordingly, an encoder may perform bypass coding on all the bins of a bin string corresponding to a TMRL index. In this case, various types of codes, such as a truncated unary code, may be employed in addition to a binarization code comprised by a prefix and a suffix.

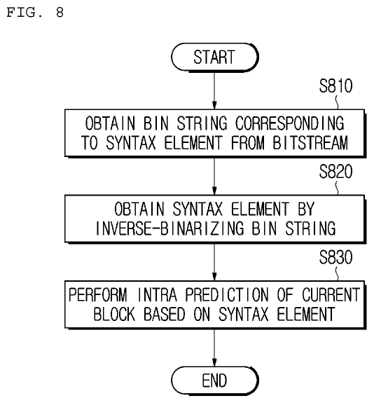

FIG. 8 is a flowchart showing an entropy decoding method according to an embodiment of the present invention.

The image decoding apparatus may obtain a bin string corresponding to a syntax element from a bitstream (S810). Herein, at least some bins of the bin string may be obtained by bypass decoding, and the remaining bins other than the bypass-coded bins of the bin string may be obtained by arithmetic decoding. In addition, the syntax element may indicate a combination of an intra prediction mode of a current block and a reference sample line used for intra prediction.

The image decoding apparatus may obtain the syntax element by inverse-binarizing the bin string (S820).

The image decoding apparatus may perform intra prediction of the current block based on the syntax element (S830).

Herein, the intra prediction of the current block may be performed by using an intra prediction mode indicated by the syntax element and a reference sample line indicated by the syntax element among a plurality of reference sample lines adjacent to the current block.

Herein, the syntax element may indicate one candidate in a candidate list including candidates indicating different combinations of intra prediction modes and reference sample lines used for intra prediction.

Herein, intra prediction modes of the candidates may be intra prediction modes other than a predetermined mode.

Herein, the candidates of the candidate list may be a plurality of candidates that are selected based on a cost value of intra prediction based on a combination of an intra prediction mode and a reference sample line.

Herein, the cost value may be determined based on a comparison result between a result value of intra prediction based on the combination of the intra prediction mode and the reference sample line and a prediction value corresponding to a template including samples adjacent to the current block.

Herein, the template may include samples of a reference sample line that is most adjacent to the current block.

Herein, the cost values may be measured through one method among a sum of absolute differences (SAD) measurement method, a sum of squared difference (SSD) measurement method, and a sum of absolute transformed differences.

Herein, the bin string may be a bin string binarized in a form of a truncated Golomb-Rice code, and the bin string may include a prefix and a suffix.

Herein, bins corresponding to the prefix of the bin string may be obtained by arithmetic decoding, and bins corresponding to the suffix of the bin string may be obtained by bypass decoding.

Herein, the bins corresponding to the prefix of the bin string and at least a portion of the bins corresponding to the suffix of the bin string may be obtained by arithmetic decoding.

Herein, the bin string may be a bin string binarized in a form of a truncated unary code, and bins not exceeding a predetermined number in the bin string may be obtained by the arithmetic decoding.

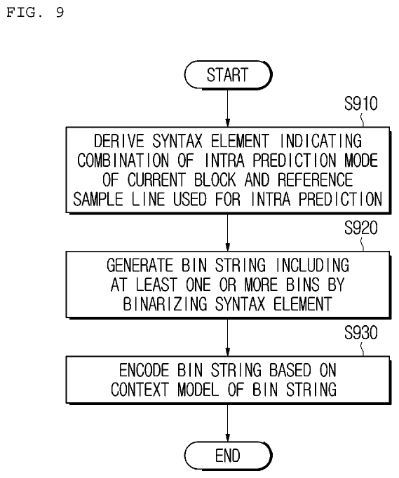

FIG. 9 is a flowchart showing an entropy encoding method according to an embodiment of the present invention.

The image encoding apparatus may derive a syntax element that indicates a combination of an intra prediction mode of a current block and a reference sample line used for intra prediction (S910).

The image encoding apparatus may generate a bin string including at least one or more bins by binarizing the syntax element (S920). Herein, bypass coding may be applied to at least some bins of the bin string, and arithmetic coding may be applied to the remaining bins other than the bypass-coded bins of the bin string.

A bitstream may be generated by encoding each bin according to an encoding method corresponding to each bin (S930).

A bitstream may be generated by an image encoding method including the steps described in FIG. 9. The bitstream may be stored in a non-transitory computer-readable recording medium and be transmitted (or streamed).

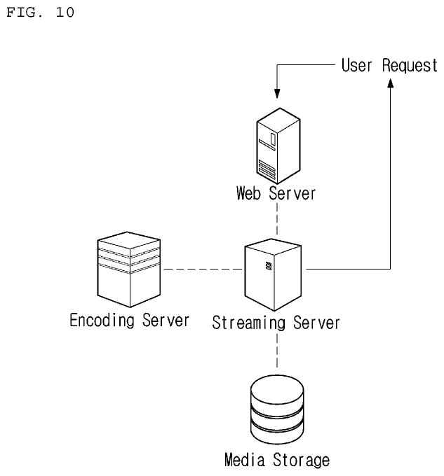

FIG. 10 is a view for illustrating a content streaming system to which an embodiment according to the present invention is applicable.

As illustrated in FIG. 10, a content streaming system to which an embodiment of the present disclosure is applied may largely include an encoding server, a streaming server, a web server, a media storage, a user device, and a multimedia input device.

The encoding server compresses content received from multimedia input devices such as smartphones, cameras, CCTVs, etc. into digital data to generate a bitstream and transmits it to the streaming server. As another example, if multimedia input devices such as smartphones, cameras, CCTVs, etc. directly generate a bitstream, the encoding server may be omitted.

The bitstream may be generated by an image encoding method and/or an image encoding apparatus to which an embodiment of the present disclosure is applied, and the streaming server may temporarily store the bitstream in the process of transmitting or receiving the bitstream.

The streaming server transmits multimedia data to a user device based on a user request via a web server, and the web server may act as an intermediary that informs the user of any available services. When a user requests a desired service from the web server, the web server transmits it to the streaming server, and the streaming server may transmit multimedia data to the user. At this time, the content streaming system may include a separate control server, and in this case, the control server may control commands/responses between devices within the content streaming system.

The streaming server may receive content from media storage and/or an encoding server. For example, when receiving content from the encoding server, the content may be received in real time. In this case, in order to provide a smooth streaming service, the streaming server may store the bitstream for a certain period of time.

Examples of the user devices may include mobile phones, smartphones, laptop computers, digital broadcasting terminals, personal digital assistants (PDAs), portable multimedia players (PMPs), navigation devices, slate PCs, tablet PCs, ultrabooks, wearable devices (e.g., smartwatches, smart glasses, HMDs), digital TVs, desktop computers, digital signage, etc.

Each server in the above content streaming system may be operated as a distributed server, in which case data received from each server may be distributed and processed.

The above embodiments may be performed in the same or corresponding manner in the encoding apparatus and the decoding apparatus. In addition, an image may be encoded/decoded using at least one or a combination of at least one of the above embodiments. The order in which the above embodiments are applied may be different in the encoding apparatus and the decoding apparatus. Alternatively, the order in which the above embodiments are applied may be the same in the encoding apparatus and the decoding apparatus.

The above embodiments may be performed for each of the luma and chroma signals. Alternatively, the above embodiments for the luma and chroma signals may be performed identically.

In the above-described embodiments, the methods are described based on the flowcharts with a series of steps or units, but the present disclosure is not limited to the order of the steps, and rather, some steps may be performed simultaneously or in different order with other steps. In addition, it should be appreciated by one of ordinary skill in the art that the steps in the flowcharts do not exclude each other and that other steps may be added to the flowcharts or some of the steps may be deleted from the flowcharts without influencing the scope of the present disclosure.

The embodiments may be implemented in a form of program instructions, which are executable by various computer components, and recorded in a computer-readable recording medium. The computer-readable recording medium may include stand-alone or a combination of program instructions, data files, data structures, etc. The program instructions recorded in the computer-readable recording medium may be specially designed and constructed for the present disclosure, or well-known to a person of ordinary skill in the computer software technology field.

A bitstream generated by the encoding method according to the above embodiment may be stored in a non-transitory computer-readable recording medium. In addition, a bitstream stored in the non-transitory computer-readable recording medium may be decoded by the decoding method according to the above embodiment.

Examples of the computer-readable recording medium include magnetic recording media such as hard disks, floppy disks, and magnetic tapes; optical data storage media such as CD-ROMs or DVD-ROMs; magneto-optimum media such as floptical disks; and hardware devices, such as read-only memory (ROM), random-access memory (RAM), flash memory, etc., which particularly structured to store and implement the program instruction. Examples of the program instructions include not only a mechanical language code formatted by a compiler but also a high-level language code that may be implemented by a computer using an interpreter. The hardware devices may be configured to be operated by one or more software modules or vice versa to conduct the processes according to the present disclosure.

Although the present disclosure has been described in terms of specific items such as detailed elements as well as the limited embodiments and the drawings, they are only provided to help more general understanding of the invention, and the present disclosure is not limited to the above embodiments. It will be appreciated by those skilled in the art to which the present disclosure pertains that various modifications and changes may be made from the above description.

Therefore, the spirit of the present disclosure shall not be limited to the above-described embodiments, and the entire scope of the appended claims and their equivalents will fall within the scope and spirit of the invention.

### INDUSTRIAL APPLICABILITY

The present disclosure may be used in an apparatus for encoding/decoding an image and a recording medium for storing a bitstream.

1. A method for decoding an image, the method comprising:
obtaining a bin string corresponding to a syntax element from a bitstream, wherein the syntax element represents a combination of an intra prediction mode of a current block and a reference sample lines used for intra prediction;
obtaining the syntax element by inverse-binarizing the bin string; and
performing the intra prediction of the current block based on the syntax element,
wherein at least a portion of bins of the bin string are obtained by bypass decoding, and bins of the bin string other than the bypass-coded bins are obtained by arithmetic decoding.

2. The method of claim 1, wherein the intra prediction of the current block uses an intra prediction mode indicated by the syntax element and a reference sample line indicated by the syntax element among a plurality of reference sample lines adjacent to the current block.

3. The method of claim 1, wherein the syntax element indicates one candidate in a candidate list including candidates indicating different combinations of intra prediction modes and reference sample lines used for intra prediction.

4. The method of claim 3, wherein the intra prediction modes of the candidates are intra prediction modes other than a predetermined mode.

5. The method of claim 3, wherein the candidates of the candidate list are a plurality of candidates that are selected based on a cost value of intra prediction based on a combination of an intra prediction mode and a reference sample line.

6. The method of claim 5, wherein the cost value is determined based on a comparison result between a result value of intra prediction based on the combination of the intra prediction mode and the reference sample line, and a prediction value corresponding to a template including samples adjacent to the current block.

7. The method of claim 6, wherein the template includes samples of a reference sample line that is most adjacent to the current block.

8. The method of claim 5, wherein the cost value is measured through one method among a sum of absolute differences (SAD) measurement method, a sum of squared difference (SSD) measurement method, and a sum of absolute transformed differences.

9. The method of claim 1, wherein the bin string is a bin string binarized in a form of a truncated Golomb-Rice code, and
the bin string includes a prefix and a suffix.

10. The method of claim 9, wherein bins corresponding to the prefix of the bin string are obtained by the arithmetic decoding, and
bins corresponding to the suffix of the bin string are obtained by the bypass decoding.

11. The method of claim 9, wherein at least a portion of the bins corresponding to the prefix of the bin string and the bins corresponding to the suffix of the bin string are obtained by the arithmetic decoding.

12. The method of claim 1, wherein the bin string is a bin string binarized in a form of a truncated unary code, and
bins not exceeding a predetermined number in the bin string are obtained by the arithmetic decoding.

13. A method for encoding an image, the method comprising:
deriving a syntax element indicating a combination of an intra prediction mode of a current block and a reference sample line used for intra prediction;
generating a bin string by binarizing the syntax element; and
generating a bitstream by encoding each bin of the bin string according to an encoding method corresponding to the each bin,
wherein bypass coding is applied to at least a portion of bins of the bin string, and arithmetic coding is applied to a bin of the bin string other than the bins to which the bypass coding is applied.

14. (canceled)

15. A method for transmitting a bitstream, the bitstream being generated by a method for encoding an image,
wherein the method for transmitting the bitstream comprises transmitting the bitstream,
wherein the method for encoding the image comprises:
deriving a syntax element indicating a combination of an intra prediction mode of a current block and a reference sample line used for intra prediction;
generating a bin string by binarizing the syntax element; and
generating a bitstream by encoding each bin of the bin string according to an encoding method corresponding to the each bin, and
wherein bypass coding is applied to at least a portion of bins of the bin string, and arithmetic coding is applied to a bin of the bin string other than the bins to which the bypass coding is applied.
